(19) United States
(12) Patent Application Publication
(10) Pub. No.: US 2023/0406752 A1
(43) Pub. Date: Dec. 21, 2023

(54) APPARATUSES AND METHODS FOR PROCESSING OPTICAL FIBER

(71) Applicant: CORNING INCORPORATED, CORNING, NY (US)

(72) Inventors: Nikolaos Pantelis Kladias, Horseheads, NY (US); Dale Robert Powers, Painted Post, NY (US); Vincent Matteo Tagliamonti, Rochester, NY (US); Chunfeng Zhou, Painted Post, NY (US)

(21) Appl. No.: 18/198,445

(22) Filed: May 17, 2023

Related U.S. Application Data
(60) Provisional application No. 63/345,070, filed on May 24, 2022.

(51) Int. Cl. C03B 37/029; F23D 14/84

(52) U.S. Cl. CPC C03B 37/029; F23D 14/84; F23D 2900/21; C03B 2205/70; C03B 2205/68

(57) ABSTRACT

A method of heating an optical fiber, the method including flowing gas from a common gas channel into one or more gas outlets of a burner, the common gas channel encircling an aperture of the burner. The method further including igniting the gas to form a flame and heating the fiber with the flame as the fiber passes through the aperture. The one or more gas outlets opening into the aperture such that each gas outlet has a gas outlet bore terminating at an inward-facing wall of the burner that defines the aperture. And the gas outlet bore being oriented at an angle θ₁ defined between the gas outlet bore and the inward-facing wall of the burner, downstream of the gas outlet bore, that is greater than or equal to 10 degrees and less than or equal to 70 degrees.

This application claims the benefit of priority under 35 U.S.C § 120 of U.S. Provisional Application Ser. No. 63/345,070 filed on May 24, 2022, the content of which is relied upon and incorporated herein by reference in its entirety.

### TECHNICAL FIELD

The present specification generally relates to apparatuses and methods for processing optical fibers and, more specifically, apparatuses and methods for reheating of an optical fiber in a fiber draw process.

### BACKGROUND

Conventional manufacturing processes for producing optical fibers generally include drawing an optical fiber downward from a draw furnace and along a pathway through multiple stages of production in an optical fiber draw tower. Once drawn from the draw furnace, the optical fiber may be cooled in a regulated manner to achieve desired fiber properties.

To meet consumer demand for optical fiber, it is desirable to increase optical fiber production within existing optical fiber draw towers. To increase optical fiber production, the rate at which the optical fiber is drawn is generally increased. However, increased draw rates may lead to increased temperatures of the optical fiber at the various stages of production, which may lead to decreased quality of the optical fiber.

Accordingly, a need exists for improved apparatuses and methods for processing an optical fiber in a draw process.

### SUMMARY

In one embodiment, a method of heating an optical fiber, the method comprising flowing gas from a common gas channel into one or more gas outlets of a burner, the common gas channel encircling an aperture of the burner. The method further comprising igniting the gas to form a flame and heating the fiber with the flame as the fiber passes through the aperture. The one or more gas outlets opening into the aperture such that each gas outlet has a gas outlet bore terminating at an inward-facing wall of the burner that defines the aperture. Additionally, the gas outlet bore being oriented at an angle θ₁ defined between the gas outlet bore and the inward-facing wall of the burner, downstream of the gas outlet bore, that is greater than or equal to 10 degrees and less than or equal to 70 degrees.

In another embodiment, a method of heating an optical fiber, the method comprising flowing gas from a common gas channel into one or more gas outlets of a burner, the common gas channel encircling an aperture of the burner. The method further comprising igniting the gas to form a flame and heating the fiber with the flame as the fiber passes through the aperture. The one or more gas outlets opening into the aperture such that each gas outlet has a gas outlet bore terminating at an inward-facing wall of the burner that defines the aperture. Additionally, the aperture having a diameter greater than or equal to 5 mm and less than or equal to 25 mm, and the one or more gas outlets each having a diameter between 0.5 mm and 1.5 mm.

In another embodiment, a method of heating an optical fiber, the method comprising flowing gas from a common gas channel into one or more gas outlets of a burner, the common gas channel encircling an aperture of the burner. The method further comprising igniting the gas to form a flame and heating the fiber with the flame as the fiber passes along a fiber conveyance pathway and through the aperture. The one or more gas outlets opening into the aperture such that each gas outlet has a gas outlet bore terminating at an inward-facing wall of the burner that defines the aperture. Additionally, an insulating member extending along the fiber conveyance pathway and on opposite sides of the burner.

In another embodiment, a reheating device for processing an optical fiber, the reheating device comprising a burner comprising a body having a top surface and a bottom surface opposite the top surface, and an aperture formed within the body and extending from the top surface through the body to the bottom surface, wherein a fiber conveyance pathway passes through the aperture. The reheating device further comprising one or more gas outlets formed within the body and opening into the aperture. The one or more gas outlets each having a gas outlet bore terminating at an inward-facing wall of the burner that defines the aperture, the gas outlet bore oriented at an angle θ₁ defined between the gas outlet bore and the inward-facing wall of the burner, downstream of the gas outlet bore, that is greater than or equal to 10 degrees and less than or equal to 70 degrees.

In another embodiment, a reheating device for processing an optical fiber, the reheating device comprising a burner comprising a body having a top surface and a bottom surface opposite the top surface, and an aperture formed within the body and extending from the top surface through the body to the bottom surface, wherein a fiber conveyance pathway passes through the aperture. The aperture having a diameter greater than or equal to 5 mm and less than or equal to 25 mm. The one or more gas outlets being formed within the body and opening into the aperture. And the one or more gas outlets each having a diameter between 0.5 mm and 1.5 mm.

In another embodiment, a reheating device for processing an optical fiber, the reheating device comprising a burner comprising a body having a top surface and a bottom surface opposite the top surface, and an aperture formed within the body extending from the top surface through the body to the bottom surface, wherein a fiber conveyance pathway passes through the aperture. The one or more gas outlets being formed within the body and opening into the aperture. And the one or more gas outlets being configured to ignite a flammable gas to form a flame encircling the optical fiber within the aperture. The reheating device further comprising an insulating member extending along the fiber conveyance pathway in a fiber conveyance direction and on opposite sides of the burner.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an embodiment of an optical fiber production apparatus, according to one or more embodiments described herein;

FIG. 2 schematically depicts another embodiment of an optical fiber production apparatus, according to one or more embodiments described herein;

FIG. 3 schematically depicts a reheating device of the optical fiber protection system of FIG. 1 or FIG. 2, according to one or more embodiments shown and described herein;

FIG. 4 graphically depicts a plot of fiber temperature versus fiber axial position in the reheating device of FIG. 3, according to one or more embodiments shown and described herein;

FIG. 5 graphically depicts a plot of heating rate versus fiber axial position in the reheating device of FIG. 3, according to one or more embodiments shown and described herein;

FIG. 6 graphically depicts a plot of fiber temperature versus fiber axial position in embodiments of the reheating device of FIG. 3 with different aperture diameters, according to one or more embodiments shown and described herein;

FIG. 7 schematically depicts a partial cross-section view of an embodiment of the reheating device of FIG. 3, according to one or more embodiments shown and described herein;

FIG. 8 graphically depicts a plot of fiber temperature versus fiber axial position in embodiments of the reheating device of FIG. 3 with a gas outlet at different angles, according to one or more embodiments shown and described herein;

FIG. 9 graphically depicts a plot of heating rate versus fiber axial position in the reheating device of FIG. 3 with a gas outlet at different angles, according to one or more embodiments shown and described herein;

FIG. 10 graphically depicts a plot of fiber temperature versus fiber axial position in embodiments of the reheating device of FIG. 3 with varying numbers and sizes of gas outlets, according to one or more embodiments shown and described herein;

FIG. 11 schematically depicts a partial cross-section view of an insulating member insulating the reheating device of FIG. 3, according to one or more embodiments shown and described herein; and

FIG. 12 graphically depicts a plot of fiber temperature versus fiber axial position in embodiments of the reheating device of FIG. 3 with varying insulating members, according to one or more embodiments shown and described herein.

### DETAILED DESCRIPTION

Embodiments described herein are directed to optical fiber production apparatuses that include a draw furnace, a muffle in communication with the draw furnace, a reheating device, and a turning device. As discussed herein, one or more parameters of the reheating device, and combinations thereof, may be modified to increase the fiber temperature and/or reduce the fictive temperature of an optical fiber drawn through the optical fiber production apparatus. Various embodiments of the apparatuses and the operation of the apparatuses are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Reference will now be made in detail to illustrative embodiments of the present description. For purposes of the present description, the illustrative embodiments relate to silica-based optical fibers, such as silica glass-based optical fibers. Silica-based optical fibers include fibers made from pure silica glass, doped silica glass, or a combination of pure and doped silica glass. Processing conditions (e.g. temperatures, cooling ranges, cooling rates, draw speeds, etc.) and properties (e.g. fictive temperature, viscosity, attenuation, refractive index, etc.) are stated in reference to silica-based optical fibers. However it should be understood that the principles of the present disclosure extend to optical fibers based on other material systems with due consideration for characteristics of the constituents of other material systems (e.g. melting temperature, viscosity, fictive temperature, time scale for structural relaxation, etc.).

In conventional fiber processing, a fiber is formed by heating a glass preform above the softening point and drawing the fiber at large draw down ratios to form optical fibers with a desired diameter. For silica glass-based fibers, the preform diameter can be on the order of about 100 mm to about 120 mm or larger and glass fibers drawn from the preform typically have a diameter of 125 μm. To manufacture silica glass fibers, the silica glass preform is heated to a temperature above 2,000° C. and the fiber is drawn at speeds of 10 m/s or higher. Due to the high draw temperatures, large draw down ratios, and fast draw speeds, the glass structure of silica-based fibers is far from equilibrium and has a fictive temperature higher than 1,500° C. Without limiting the scope of the present disclosure, it is believed that the non-equilibrium structure of silica glass fibers is a significant underlying cause of signal attenuation in silica glass fibers. It is accordingly believed that lower attenuation can be achieved in optical fibers by modifying processing conditions to stabilize glass structures and reducing fictive temperature of the glass optical fiber.

One of the challenges in drawing optical fiber is that the glass network rapidly cools after forming. This results in a limited envelope of time in which subsequent process steps that require the glass to be above a certain temperature can be performed. Fictive temperature of the fiber core can also be reduced via fiber reheating, which can reduce the Rayleigh scattering related attenuation of optical signals in the finished optical fiber. Rayleigh scattering is responsible for the majority of the optical attenuation in wavelength ranges of interest. The methods and apparatuses described herein reduce Rayleigh scattering and thereby reduce fiber optical attenuation.

Compaction, also referred to as thermal stability or dimensional change, is an irreversible dimensional change (shrinkage) in the glass substrate due to changes in the fictive temperature of the glass. Fictive temperature of a glass is the temperature at which the corresponding liquid structure and properties are “frozen in” or permanently associated with the glass upon cooling. Therefore, fictive temperature is dependent upon the cooling rate of the glass substrate. Fictive temperature is obtained as the temperature at which the property of interest (e.g., specific volume or enthalpy) intersects the equilibrium liquid line. Fictive temperature may be determined by estimating the recovered enthalpy of heating and analyzing a relationship between the recovered enthalpy with changes in the internal energy and changes in the configurational entropy. For purposes of the present description, “fictive temperature” refers to a concept used to indicate the structural state of a glass. Glass that is cooled quickly from a high temperature typically exhibits a higher fictive temperature than an identical glass cooled from the same temperature more slowly because of the “frozen in” higher temperature structure. When a glass is held at an elevated temperature, the glass structure is allowed more time to relax toward the heat treatment temperature structure. Glasses with high fictive temperature have structures that are further removed from equilibrium than glasses with low fictive temperature. Processing conditions that lower the fictive temperature of the glass produce optical fibers with lower attenuation. Accordingly, it should be appreciated that, as discussed herein, it is an object of the present disclosure to achieve a higher fiber temperature of the optical fibers, without exceeding the fictive temperature of the optical fiber, while also reducing the fictive temperature of the optical fiber. The closer the maximum fiber temperature is to the fictive temperature, without exceeding the fictive temperature, the greater the reduction in the fictive temperature.

Processing conditions that extend the period of time in which the fiber is exposed to temperatures in the glass transition region or the near-glass transition region facilitate relaxation of the structure of the fiber and reduce the fictive temperature of the fiber. As used herein, a glass transition region is a temperature range that includes the glass transition temperature (Tg). The phrase “glass transition temperature,” as used herein, refers to the temperature at which a glass has a viscosity from about log 13 to about log 13.5 poise. In one embodiment, the glass transition region extends from below the glass transition temperature to above the glass transition temperature. The glass transition region generally ranges between 1,200° C. and 1,700° C. for silica glass optical fibers. There may be additional relaxation of the glass or inducement of the glass toward a more nearly equilibrium state below the glass transition region (near-Tg region), which, for silica-based fibers, corresponds to temperatures between 1,000° C. and 1,200° C.

Reference will now be made in detail to embodiments of apparatuses and methods for producing optical fibers, examples of which are illustrated in the accompanying drawings. Whenever possible, the same reference numerals will be used throughout the drawings to refer to the same or like parts.

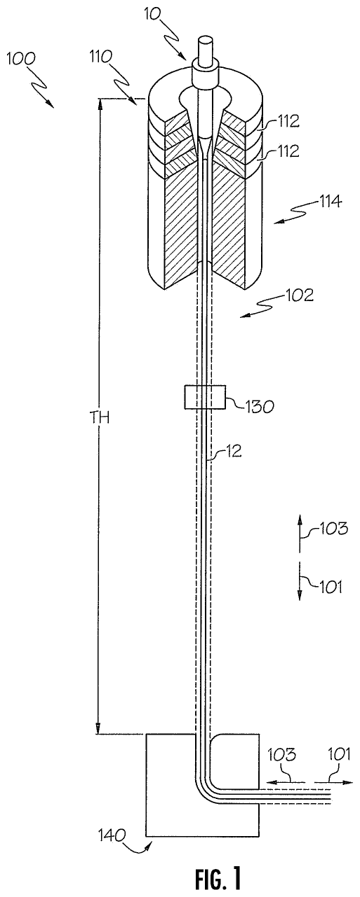

Referring now to FIG. 1, an exemplary optical fiber production apparatus 100 is illustrated according to one or more embodiments described herein. The optical fiber production apparatus 100 generally includes a draw furnace 110, a muffle 114 in communication with the draw furnace 110, a reheating device 130, and a turning device 140. In embodiments, the optical fiber production apparatus 100 may be positioned within a draw tower having a height TH that generally corresponds to a distance between the draw furnace 110 and the turning device 140. In some embodiments, the optical fiber production apparatus 100 may include one or more devices that further process the optical fiber downstream of the turning device 140, such as a fiber coating device and the like.

The optical fiber production apparatus 100 generally defines a fiber conveyance pathway 102 that extends from the draw furnace 110 through the turning device 140. As described in greater detail herein, an optical fiber 12 travels along the fiber conveyance pathway 102 in a fiber conveyance direction 101. As referred to herein, the terms “downstream” and “downward” generally refer to the relative position of components of the optical fiber production apparatus 100 in the fiber conveyance direction 101 along the fiber conveyance pathway 102. The terms “upstream” and “upward” refer to the relative position of components of the optical fiber production apparatus 100 in a counter-conveyance direction 103 that is opposite the fiber conveyance direction 101 along the fiber conveyance pathway 102. By way of example, the turning device 140 is downstream of the draw furnace 110. Similarly, the draw furnace 110 is upstream of the turning device 140. In embodiments, the fiber conveyance pathway 102 generally extends between an upstream end at the draw furnace 110 and a downstream end positioned opposite the upstream end. Between the draw furnace 110 and the turning device 140, the fiber conveyance pathway 102 generally extends in a vertical direction in which the draw furnace 110 is positioned above the turning device 140. However, in embodiments, the reheating device 130 may be located downstream of the turning device 140.

An optical fiber preform 10 is placed in the draw furnace 110. The optical fiber preform 10 may be constructed of any glass or material suitable for the manufacture of optical fibers such as silica glass or the like. In some embodiments, the optical fiber preform 10 may include a homogenous composition throughout the optical fiber preform 10. In some embodiments, the optical fiber preform 10 may include regions having different compositions.

The draw furnace 110 includes one or more heating elements 112 that heat the optical fiber preform 10 such that the optical fiber 12 may be drawn from the optical fiber preform 10. In embodiments, the heating elements 112 generally include any elements suitable for generating thermal energy, for example, induction coils and the like. A section view of the draw furnace 110 is depicted in FIG. 1, however, it should be understood that the draw furnace 110 may define any suitable shape surrounding the optical fiber preform 10. In embodiments, the draw furnace 110 is oriented in the vertical direction such that a downstream end of the draw furnace 110 is positioned below the optical fiber preform 10. The optical fiber 12 may be drawn from the optical fiber preform 10 as the optical fiber preform 10 softens due to heating by the draw furnace 110. By orienting the draw furnace 110 in the vertical direction, as the optical fiber preform 10 softens, portions of the optical fiber preform 10 may yield under their own weight to form the optical fiber 12, and the optical fiber 12 may be drawn along the fiber conveyance pathway 102. In some embodiments, the optical fiber production apparatus 100 may include a fiber collection unit positioned at the downstream end of the fiber conveyance pathway 102, and the fiber collection unit may apply tension to the optical fiber 12 to draw the optical fiber 12 along the fiber conveyance pathway 102. In embodiments, the optical fiber 12 includes a cladding positioned around a core of the optical fiber 12. In embodiments, the cladding comprises a refractive index that is different than the core of the optical fiber 12. For example, in embodiments, the core may have a higher refractive index than the cladding, and may assist in restricting light from passing out of the core, for example, when the optical fiber 12 is used as an optical waveguide

In embodiments, once the optical fiber 12 exits the draw furnace 110, the optical fiber 12 enters the muffle 114. A section view of the muffle 114 is depicted in FIG. 1, however like the draw furnace 110, it should be understood that the muffle 114 may define a shape surrounding the fiber conveyance pathway 102. In embodiments, the muffle 114 is in communication with the draw furnace 110 and may be coupled to the downstream end of the draw furnace 110. In embodiments, the muffle 114 includes a gas environment that is similar to or the same as the draw furnace 110. For example, in some embodiments, an inert gas or gas mixture, such as helium gas or a helium gas mixture is utilized within the draw furnace 110. In some embodiments, other inert gases or other inert gas mixtures including and without limitation, nitrogen and/or argon, may be utilized within the draw furnace 110. Helium gas has a relatively high thermal conductivity and may accordingly facilitate a higher rate of heat transfer from the optical fiber 12 as compared to ambient air or other gas mixtures. Accordingly, in embodiments in which the draw furnace 110 contains a gas environment including helium or a helium mixture, the same helium or helium mixture gas environment within muffle 114 may facilitate comparatively efficient cooling of the optical fiber 12 within the muffle 114.

The turning device 140 is positioned on the fiber conveyance pathway 102 downstream of the reheating device 130, and in embodiments, the turning device 140 changes the fiber conveyance direction 101. For example, in embodiments, the turning device 140 includes one or more fluid bearings or the like that redirects the optical fiber 12, changing the fiber conveyance direction 101. Upstream of the turning device 140, the fiber conveyance direction 101 generally extends in the vertical direction and the turning device 140 directs the optical fiber 12 in a direction that is transverse to or at an angle to the vertical direction. In the embodiments in which the turning device 140 includes one or more fluid bearings, the turning device 140 redirects the optical fiber 12 by impinging fluid (e.g., nitrogen, argon, helium, air, or the like) on the optical fiber 12.

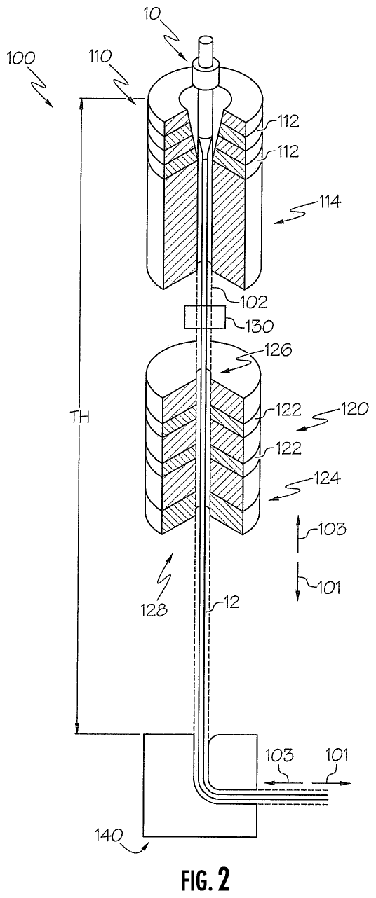

FIG. 2 depicts another exemplary optical fiber production apparatus 100 which generally includes the draw furnace 110, the muffle 114 in communication with the draw furnace 110, the reheating device 130, and the turning device 140. In addition, the optical fiber production apparatus 100 includes a cooling device 120 provided downstream of the draw furnace 110. Accordingly, the turning device 140 is downstream of the cooling device 120, which is downstream of the draw furnace 110. Similarly, the draw furnace 110 is upstream of the cooling device 120, which is upstream of the turning device 140. However, in embodiments, the reheating device 130 and the cooling device 120 may be located downstream of the turning device 140.

In some embodiments, downstream from the reheating device 130, the optical fiber 12 enters the cooling device 120. A section view of the cooling device 120 is depicted in FIG. 2, however, it should be understood that in embodiments the cooling device 120 may define a shape that surrounds the fiber conveyance pathway 102. In the embodiment depicted in FIG. 2, the cooling device 120 is spaced apart from the muffle 114, the draw furnace 110, and the reheating device 130 along the fiber conveyance pathway 102.

In embodiments, the cooling device 120 extends between an inlet 126 and an outlet 128 positioned opposite the inlet 126. The optical fiber 12 generally enters the cooling device 120 at the inlet 126 and exits the cooling device 120 at the outlet 128. The cooling device 120 includes one or more cooling device heating elements 122 that apply heat to the optical fiber 12 as it passes through the cooling device 120. In some embodiments, the one or more cooling device heating elements 122 generally include any element suitable for generating thermal energy, for example and without limitation, induction coils or the like. The cooling device 120 may assist in reducing the cooling rate of the optical fiber 12 while the optical fiber 12 is in a glass transition region. Reducing the cooling rate of the optical fiber 12 in the glass transition region may generally assist in allowing the glass network of the optical fiber 12 to rearrange in a manner that reduces attenuation resulting from Rayleigh scattering when the optical fiber 12 is utilized as an optical waveguide.

In some embodiments, the optical fiber production apparatus 100 further includes an airflow manifold 124 that provides clean air (i.e., ambient air not impacted by the fiber production process) to the cooling device 120. The airflow manifold 124 may be positioned downstream of and may be in fluid communication with the cooling device 120.

Referring again to the fiber production apparatus of FIG. 1, downstream from the muffle 114, the optical fiber 12 enters a reheating device 130. The reheating device 130 is configured to heat the optical fiber 12 to a temperature within a glass transformation temperature range of the optical fiber. By rapidly heating the optical fiber temperature to the glass transformation temperature range, the fictive temperature of the optical fiber 12 can be reduced. As a consequence, Rayleigh scattering from the fiber core may also be reduced. In the embodiment depicted in FIG. 1, the reheating device 130 is spaced apart from the muffle 114 and the draw furnace 110 along the fiber conveyance pathway 102. Embodiments of the reheating device 130 heat the optical fiber 12 from a first temperature when entering the reheating device 130 to a target peak temperature, higher than the first temperature. In some embodiments, the first temperature of the optical fiber 12 when entering the reheating device 130 is about 20° C. to about 1,500° C. In some embodiments, the target peak temperature of the optical fiber 12 within the reheating device 130 is about 900° C. to about 1,600° C. Embodiments of the reheating device 130 described herein heat the optical fiber 12 to a target peak temperature exceeding 1,100° C., or to a target peak temperature exceeding 1,200° C., or to a target peak temperature exceeding 1,250° C. Embodiments of the reheating device 130 described herein heat the optical fiber 12 by at least 100° C., or by at least 200° C., or by at least 500° C. Embodiments of the reheating device 130 described herein heat the optical fiber 12 at a heating rate of rate greater than about 10,000° C./second, or at a rate greater than about 20,000° C./second, or at a rate of 50,000° C./second. In embodiments, the reheating device 130 achieves a peak heating rate equal to or greater than 60,000° C./second. The optical fiber 12 may be subsequently cooled from the target peak temperature to a second temperature by the cooling device 120, discussed herein, such that a target fictive temperature is obtained in the optical fiber 12. In some embodiments, the second temperature of the optical fiber 12 is about 700° C. to about 1,400° C. In some embodiments, the target fictive temperature of the optical fiber 12 is about 800° C. to about 1,500° C. or about 900° C. to about 1,400° C., or about 1,000° C. to about 1,200° C.

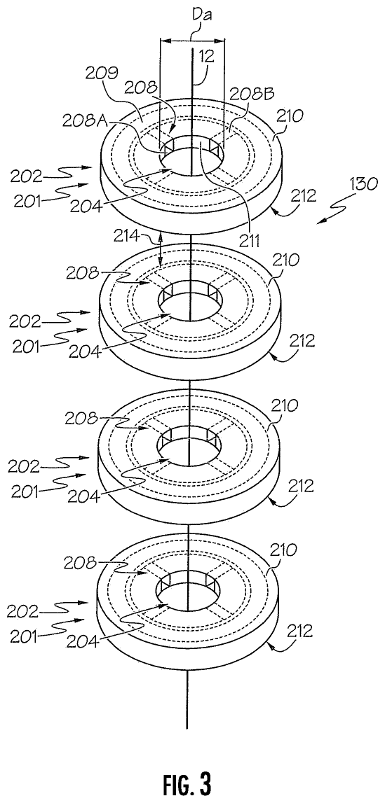

Referring now to FIG. 3, an exemplary reheating device 130 is illustrated comprising a plurality of burners 201. In some embodiments, the reheating device 130 has a length greater than or equal to 25 cm and less than or equal to 400 cm. In some embodiments, the reheating device 130 has a length greater than or equal to 50 cm and less than or equal to 350 cm, or greater than or equal to 75 cm and less than or equal to 300 cm, or greater than or equal to 100 cm and less than or equal to 250 cm, or greater than or equal to 150 cm and less than or equal to 200 cm.

In some embodiments, the reheating device 130 comprises four burners 201. The reheating device 130 may contain more or less burners 201 than that depicted in the exemplary embodiment, for example, one, two, three, or more than four burners 201. Each burner 201 includes a body 202 having a top surface 210 and a bottom surface 212 opposite the top surface 210. A radially inward-facing wall 211 extends between the top surface 210 and the bottom surface 212. The bottom surface 212 faces the fiber conveyance direction 101 (FIG. 1) and the top surface 210 faces the counter-conveyance direction 103 (FIG. 1). A thickness of the body 202 extending between opposite top and bottom surfaces 210, 212 may be about 10 mm. In other embodiments, the thickness of the body 202 may be less than 10 mm or greater than 10 mm. In some embodiments, a distance 214 from the bottom surface 212 of one body 202 to the top surface 210 of an adjacent body 202 is greater than or equal to 50 mm and less than or equal to 250 cm. In some embodiments, the distance 214 is greater than or equal to 100 mm and less than or equal to 200 mm.

Each body 202 has an aperture 204 extending from the top surface 210 through the body 202 to the bottom surface 212 and defined by the inward-facing wall 211. The fiber conveyance pathway 102, through which the optical fiber 12 passes, extends through the aperture 204. The aperture 204 formed in the body 202 has an aperture diameter Da. In embodiments, the aperture diameter Da is greater than or equal to 5 mm and less than or equal to 25 mm. It should be appreciated that if the aperture diameter Da is greater than 25 mm, the concentration of burning gas will be dispersed over a larger area rather than being focused on the optical fiber 12. Alternatively, if the aperture diameter Da is less than 5 mm, this may result in too narrow of a passageway for gas to flow through the fiber conveyance pathway 102, thus limiting the burning potential. In embodiments, the aperture diameter Da is greater than or equal to 7 mm and less than or equal to 14 mm. In embodiments, the aperture diameter Da is greater than or equal to 8 mm and less than or equal to 12 mm.

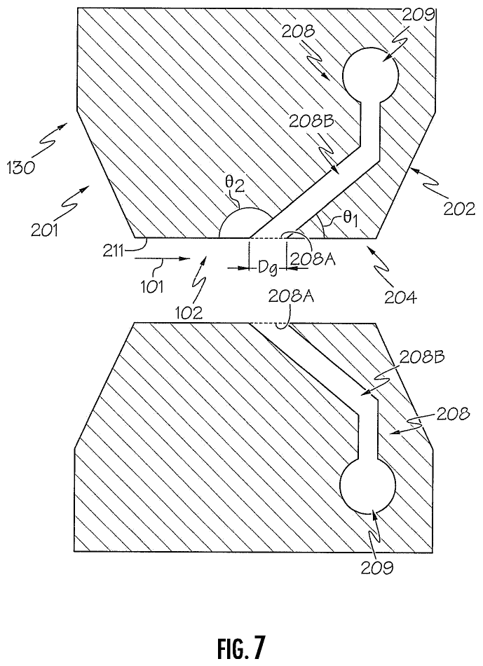

In embodiments, one or more gas outlets 208 are formed within each body 202 and terminate at the aperture 204 defining a gas outlet nozzle 208A within. In some embodiments, the one or more gas outlets 208 comprises a plurality of gas outlets 208 with each gas outlet 208 comprising a gas outlet bore 208B extending from a common gas channel 209 and directed toward the aperture 204. As shown in FIG. 3, the common gas channel 209 is formed within the body 202 between the top surface 210 and the bottom surface 212 and encircles the aperture 204. In some embodiments, each gas outlet nozzle 208A has a gas outlet diameter Dg (FIG. 7) of greater than or equal to 0.05 mm and less than or equal to 2 mm. It should be appreciated that if the gas outlet Dg is greater than 2 mm, the rate of gas flowing through the gas outlets 208 will be reduced and thus not flow through the fiber conveyance pathway 102 at an optimal rate. Similarly, if the gas outlet Dg is less than 0.05 mm, this may result in a significant pressure drop at the gas outlets 208, thus reducing the rate at which the gas flows through gas outlets 108 as well. In some embodiments, the gas outlet diameter Dg is greater than or equal to 0.1 mm and less than or equal to 2 mm, or greater than or equal to 0.5 mm and less than or equal to 1.5 mm, or greater than or equal to 1 mm and less than or equal to 2 mm. In some embodiments, each body 202 includes a plurality of gas outlet nozzles 208A such as, for example, greater than or equal to 2 gas outlet nozzles 208A and less than or equal to 50 gas outlet nozzles 208A, greater than or equal to 3 gas outlet nozzles 208A and less than or equal to 20 gas outlet nozzles 208A, or greater than or equal to 3 gas outlet nozzles 208A and less than or equal to 12 gas outlet nozzles 208A. In some embodiments, each gas outlet nozzle 208A is positioned equidistant from an adjacent gas outlet nozzle 208A. In embodiments in which a plurality of gas outlets 208 are provided, the gas outlet bore 208B of each gas channel 208 extends from the common gas channel 209, thereby placing each of the gas outlets 208 in fluid communication with one another. Combustible gas from one or more gas outlets 208 within the body 202 is ignited to form a flame encircling the optical fiber 12 extending through the fiber conveyance pathway 102 and passing through the aperture 204 to heat the optical fiber 12. In some embodiments, each body 202 provides a volumetric flow rate of combustible gas from about 2 slpm (standard liter per minute) to about 8 slpm. In some embodiments, the combustible gas is a mixture of oxygen and at least one of methane, ethane, propane, carbon monoxide (CO), or hydrogen. In some embodiments, the ratio of the at least one of methane, ethane, propane, carbon monoxide (CO), or hydrogen to the oxygen is higher than their stoichiometric ratio.

In use, the optical fiber 12 is conveyed through the fiber conveyance pathway 102 and through the reheating device 130 at a velocity of greater than or equal to 2 m/s and less than or equal to 100 m/s. The optical fiber 12 enters the reheating device 130 at the inlet portion of a first one of the bodies 202 and exits the reheating device 130 at the outlet portion of a last one of the bodies 202. The optical fiber 12, having a first temperature, is heated to a target peak temperature such that a target fictive temperature is obtained in a region of the optical fiber 12 within the reheating device 130. In some embodiments, the first temperature of the optical fiber 12 when entering the reheating device 130 is greater than or equal to 20° C. and less than or equal to 1,500° C. In some embodiments, the target peak temperature of the optical fiber 12 within the reheating device 130 is greater than or equal to 900° C. and less than or equal to 1,600° C. In some embodiments, the attenuation of the reheated optical fiber 12 is reduced by 0.002 dB/km or less at a wavelength of 1310 nm or reduced by 0.001 dB/km or less at a wavelength 1550 nm. The reduction in attenuation is due to the reheating process of reheating device 130.

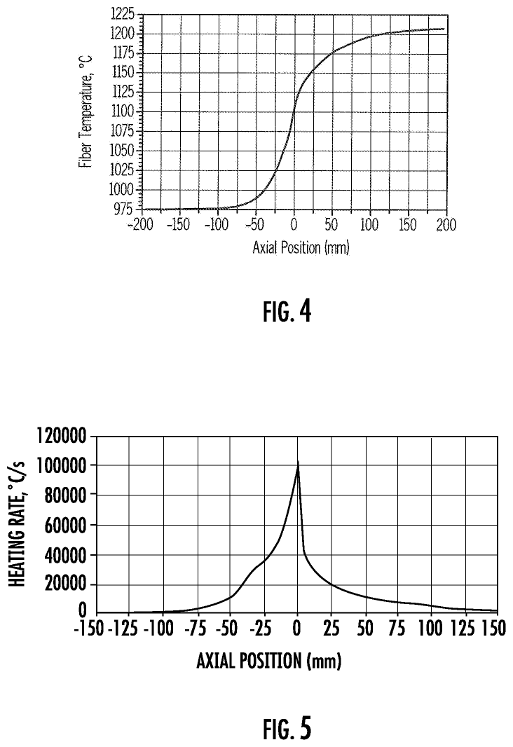

Referring now to FIG. 4, a plot of fiber temperature versus fiber axial position in and surrounding a reheating device 130 with a single burner 201 is depicted. The plot shows a sharp increase of temperature close to the reheating device 130. The majority of the temperature increase is within 100 mm of space near a center plane, i.e., axial position of 0 mm, of the reheating device 130 such as, for example, within 50 mm of the center plane of the reheating device 130. The center plane of the reheating device 130 is defined by a middle point of the reheating device 130 extending along the fiber conveyance pathway 102. The positive axial positions, i.e., 0 mm to 200 mm, refer to a distance downstream of the center plane of the reheating device 130 and extending toward the turning device 140. Similarly, the negative axial positions, i.e., −200 mm to 0 mm, refer to a distance upstream of the center plane of the reheating device 130 and extending toward the draw furnace 110. It should be appreciated that the reheating device 130 utilized in FIGS. 4 and 5 includes only a single body 202, which has a total thickness of about 10 mm extending between opposite top and bottom surfaces 210, 212, and, thus, the reheating device 130 extends only a portion of the total axial length illustrated in FIG. 4, which indicates a portion of the fiber conveyance pathway 102. The same applies to each of the plots depicted in FIGS. 5, 6, 8-10, and 12. As shown in FIG. 4, the optical fiber 12 is heated to a temperature of about 1,100° C. when at the center plane of the reheating device 130. The optical fiber 12 is then heated to a maximum temperature between 1,200° C. and 1,225° C. at 200 mm from the center plane of the reheating device 130.

Referring now to FIG. 5, a plot indicating modeled data of fiber heating rate versus fiber axial position in a reheating device 130 with a single burner 201 is depicted. The plot shows the fiber heating rate is less than about 4,000° C./second till about the −75 mm axial position. The fiber heating rate than increases, with a maximum heating rate of about 100,000° C./second at the center plane of the reheating device 130 (at the axial position of 0 mm). Then, the heating rate decreases and approaches 4,000° C./second at about the 100 mm axial position. The heating rate is therefore greatest at the center plane of the reheating device 130.

It should be appreciated that the plots illustrated in FIGS. 4 and 5 depict modeled data of a baseline reheating device 130 having a single burner 201 with a body 202 with an aperture diameter Da of 9 mm. The body 202 has 12 gas outlet nozzles 208A each having a gas outlet diameter Dg of 0.635 mm. The fuel volume flow rate is 6.77 slpm and the fuel (CH₄) to oxygen ratio is 1:1.6. The fiber temperature and the heating rate may be modified to reduce the fictive temperature of the optical fiber 12 by modifying one or more parameters of the optical fiber production apparatus 100 such as, for example, the reheating device 130. More specifically, by having more than one burner 201, by modifying the aperture diameter Da of each burner 201, by modifying an orientation of each gas outlet 208 of each burner 201, by modifying a size and number of gas outlet nozzles 208A of each burner 201, and/or by providing an insulating member 216. Additionally, as discussed herein, by modifying a combination of these parameters, a higher heating rate and fiber temperature may be achieved resulting in a reduced fictive temperature.

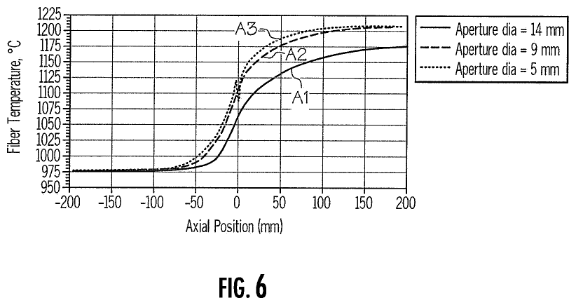

Referring now to FIG. 6, a plot indicating modeled data of fiber temperature versus fiber axial position of a reheating device 130 with a single burner 201 is depicted. FIG. 6 includes a plot line A1 representing an aperture diameter Da of 14 mm, a plot line A2 representing an aperture diameter Da of 9 mm, and a plot line A3 representing an aperture diameter Da of 5 mm. In each of the plot lines A1-A3, the fiber temperature exhibits the most significant increase within 100 mm of the center plane of the reheating device 130 and, more specifically, within 50 mm of the center plane of the reheating device 130.

The plot line A1 indicates a temperature between 1,050° C. and 1,075° C. at the center plane of the reheating device 130, and a maximum temperature of about 1,175° C. at 200 mm from the center plane of the reheating device 130. The plot line A2 indicates a temperature between 1,075° C. and 1,125° C. at the center plane of the reheating device 130, and a maximum temperature between 1,200° C. and 1,225° C. at 200 mm from the center plane. Similarly, the plot line A3 indicates a temperature between 1,075° C. and 1,125° C. at the center plane of the reheating device 130, and a maximum temperature between 1,200° C. and 1,225° C. at 200 mm from the center plane. However, the plot line A3 representing an aperture diameter Da of 5 mm indicates a temperature dip at the center plane of the reheating device 130 caused by cold gas impinging on the optical fiber 12. In addition, the plot line A1 representing an aperture diameter Da of 14 mm indicates the lowest temperature at the center plane of the reheating device 130. Accordingly, it is preferred that the aperture diameter Da of the body 202 of the burner 201 be greater than or equal to 5 mm and less than 14 mm to achieve the highest fiber temperature without experiencing any temperature dips. In embodiments, the aperture diameter Da of the body 202 of the burner 201 is greater than or equal to 7 mm and less than or equal to 12 mm. In embodiments, the aperture diameter Da of the body 202 of the burner 201 is greater than or equal to 8 mm and less than or equal to 10 mm. It should be appreciated that such temperature dips exhibited with an aperture diameter Da of 5 mm is unexpected and, thus, it is not preferred to provide an aperture diameter Da less than 5 mm.

Referring now to FIG. 7, a partial cross-section view of an embodiment of one of the burners 201 of the reheating device 130 of the embodiments disclosed herein is illustrated depicting a pair of gas outlets 208. As discussed herein, the body 202 of the burner 201 includes one or more gas outlets 208 terminating at the aperture 204 of the body 202. The one or more gas outlets 208 defines a gas outlet nozzle 208A opening at the aperture 204 and a gas outlet bore 208B extending between the gas outlet nozzle 208A and the common gas channel 209 through which gas is distributed to each of the gas outlets 208. The gas outlet nozzle 208A has a gas outlet diameter Dg, as discussed above, defining a width of the gas outlet nozzle 208A formed in the inward-facing wall 211 of the body 202. In embodiments, the one or more gas outlets 208 directs gas at a non-perpendicular direction relative to the fiber conveyance pathway 102 extending through the aperture 204. As such, the one or more gas outlets 208 may be configured to direct gas into the aperture 204 at an oblique angle relative to the fiber conveyance pathway 102. In embodiments, the gas outlet bore 208B is formed within the body 202 and extends at an oblique angle relative to the fiber conveyance pathway 102 to direct gas through the fiber conveyance pathway 102 in the counter-conveyance direction 103. As such, a first angle θ₁ extending between the gas outlet bore 208B and the inward-facing wall 211 downstream of the gas outlet nozzle 208A is less than 90 degrees and a second angle θ₂ extending between the gas outlet bore 208B and the inward-facing wall 211 upstream of the gas outlet nozzle 208A is greater than 90 degrees. As illustrated in FIG. 7, a bend is formed in the gas outlet bore 208B. However, it should be appreciated that the bend may not be formed in the gas outlet bore 208B such that the gas outlet bore 208B extends linearly from the common gas channel 209 to the gas outlet nozzle 208A. In other embodiments, the gas outlet bore 208B may be curved from the common gas channel 209 to the gas outlet nozzle 208A. In any event, the gas outlet bore 208B may include a linear portion extending from the gas outlet nozzle 208A having a length at least five times the gas outlet diameter Dg. In embodiments, the length of the linear portion of the gas outlet bore 208B is at least ten times the gas outlet diameter Dg.

In embodiments, the first angle θ₁ is greater than or equal to 10 degrees and less than or equal to 80 degrees, such that the second angle θ₂ is greater than or equal to 100 degrees and less than or equal to 170 degrees. In embodiments, the first angle θ₁ is greater than or equal to 20 degrees and less than or equal to 60 degrees, such that the second angle θ₂ is greater than or equal to 120 degrees and less than or equal to 160 degrees. In embodiments, the first angle θ₁ is greater than or equal to 30 degrees and less than or equal to 50 degrees, such that the second angle θ₂ is greater than or equal to 130 degrees and less than or equal to 150 degrees.

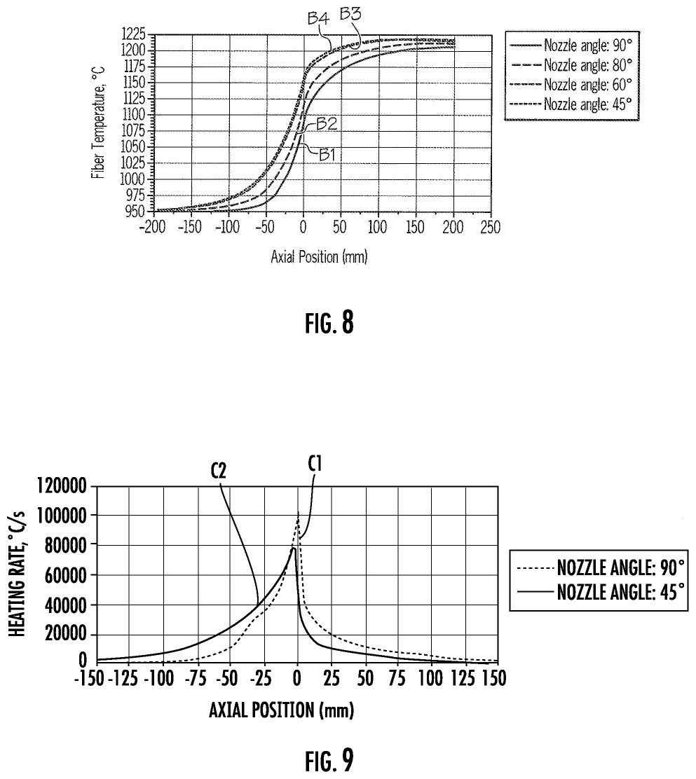

Referring now to FIG. 8, a plot indicating modeled data of fiber temperature versus fiber axial position of a reheating device 130 with a single burner 201 is depicted. FIG. 8 includes a plot line B1 representing a first angle θ₁ of 90 degrees, i.e., perpendicular to the fiber conveyance pathway 102, a plot line B2 representing a first angle θ₁ of 80 degrees, a plot line B3 representing a first angle θ₁ of 60 degrees, and a plot line B4 representing a first angle θ₁ of 45 degrees. In each of the plot lines B-B4, the fiber temperature exhibits the most significant increase within 100 mm of the center plane of the reheating device 130 and, more specifically, within 50 mm of the center plane of the reheating device 130.

The plot line B1 indicates a temperature between 1,075° C. and 1,100° C. at the center plane of the reheating device 130, and a maximum temperature between 1,200° C. and 1,225° C. at 200 mm from the center plane of the reheating device 130. The plot line B2 indicates a temperature between 1,100° C. and 1,125° C. at the center plane of the reheating device 130, and a maximum temperature between 1,200° C. and 1,225° C. at 200 mm from the center plane, but greater than the maximum temperature of plot line B1. The plot line B3 and the plot line B4 each indicate a temperature of about 1,150° C. at the center plane of the reheating device 130, and a maximum temperature between 1,200° C. and 1,225° C. at 200 mm from the center plane, but greater than the maximum temperature of plot line B1 and plot line B2. It should be appreciated that the plot line B4, which represents a first angle θ₁ of 45 degrees, provides the greatest maximum temperature.

Referring now to FIG. 9, a plot indicating modeled data of fiber heating rate versus fiber axial position of a reheating device 130 with a single burner 201 is depicted. FIG. 9 includes a plot line C1 representing a first angle θ₁ of 90 degrees, and a plot line C2 representing a first angle θ₁ of 45 degrees. The plot shows the fiber heating rate of the plot line C1 and the plot line C2 each has a peak of greater than 60,000° C./second at the center plane of the reheating device 130. Specifically, the plot shows the fiber heating rate of the plot line C1 has a peak of about 100,000° C./second at the center plane of the reheating device 130. Additionally, the plot shows the fiber heating rate of the plot line C2 has a peak of about 80,000° C./second at the center plane of the reheating device 130. However, the plot line C2 provides a higher fiber reheating rate upstream of the center plane of the reheating device 130 than the plot line C1, which ultimately contributes more to producing a higher fiber temperature than the peak heating rate. The plot line C2 provides an average heating rate of about 10,600° C./second within 150 mm of the center plane of the reheating device 130, which is greater than the average heating rate of the plot line C1 being about 10,050° C./second within 150 mm of the center plane of the reheating device 130. Accordingly, it is preferred that the first angle θ₁ is 45 degrees (as compared to a first angle θ₁ of 90 degrees) to achieve the highest fiber temperature. However, as discussed herein, the first angle θ₁ may be equal to or greater than 20 degrees and less than or equal to 60 degrees, and, in some embodiments, greater than or equal to 30 degrees and less than or equal to 50 degrees. Despite the fact that an increased peak heating rate is provided when the first angle θ₁ is 90 degrees as compared to when the first angle θ₁ is 45 degrees, it is unexpected that the average heating rate would be greater when the first angle θ₁ is 45 degrees as compared to when the first angle θ₁ is 90 degrees. Accordingly, the total heating or cumulative heating provided when the first angle θ₁ is 45 degrees is greater than the total heating or cumulative heating provided when the first angle θ₁ is 90 degrees.

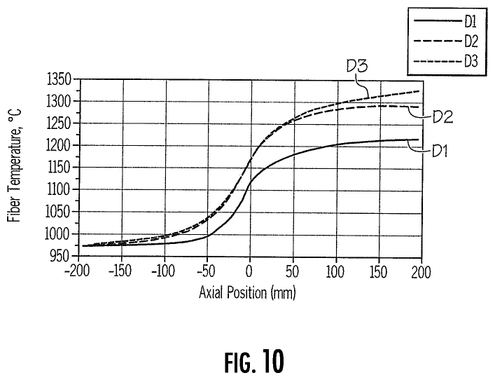

It should also be appreciated that the number of gas outlet nozzles 208A and the size of the gas outlet nozzle 208A formed in the inward-facing wall 211 of the body 202 of the burner 201 has an impact on the resulting fiber temperature passing through the reheating device 130. Accordingly, in embodiments, a gas outlet diameter Dg (FIG. 7) of the gas outlet nozzle 208A is greater than or equal to 0.05 mm and less than or equal to 2 mm. Referring now to FIG. 10, a plot indicating modeled data of fiber temperature versus fiber axial position of a reheating device 130 with a single burner 201 is depicted. FIG. 10 includes a plot line D1, a plot line D2, and a plot line D3 each representing a reheating device 130 with a body 202 having a different aperture diameter Da, a different number of gas outlets 208, and/or a different gas outlet diameter Dg. For example, D1 represents a reheating device 130 wherein the body 202 has an aperture diameter Da of 8.74 mm, has 12 gas outlets 208, and the gas outlet diameter Dg of each gas outlet nozzle 208A is 0.6 mm, the plot line D2 represents a reheating device 130 wherein the burner 202 has an aperture diameter Da of 12.7 mm, has 16 gas outlets 208, and the gas outlet diameter Dg of each gas outlet nozzle 208A is 0.6 mm, and the plot line D3 represents a reheating device 130 wherein the burner 202 has an aperture diameter Da of 12.7 mm, has 16 gas outlets 208, and the gas outlet diameter Dg of each gas outlet nozzle 208A is 0.1 mm.

The plot line D1 indicates a temperature between 1,100° C. and 1,150° C. at the center plane of the reheating device 130, and a maximum temperature between 1,200° C. and 1,250° C. at 200 mm from the center plane of the reheating device 130. The plot line D2 indicates a temperature between 1,150° C. and 1,200° C. at the center plane of the reheating device 130, and a maximum temperature between 1,250° C. and 1,300° C. at 200 mm from the center plane, and thus greater than the maximum temperature of the plot line D1. The plot line D3 indicates a temperature between 1,150° C. and 1,200° C. at the center plane of the reheating device 130, and a maximum temperature between 1,300° C. and 1,350° C. at 200 mm from the center plane, and thus greater than the maximum temperature of the plot line D1 and the plot line D2. Accordingly, in embodiments in which the aperture diameter Da is greater than or equal to 10 mm and less than or equal to 14 mm, it is preferred that each burner 202 have 12 gas outlets 208 each with a gas outlet diameter Dg of 0.6 mm.

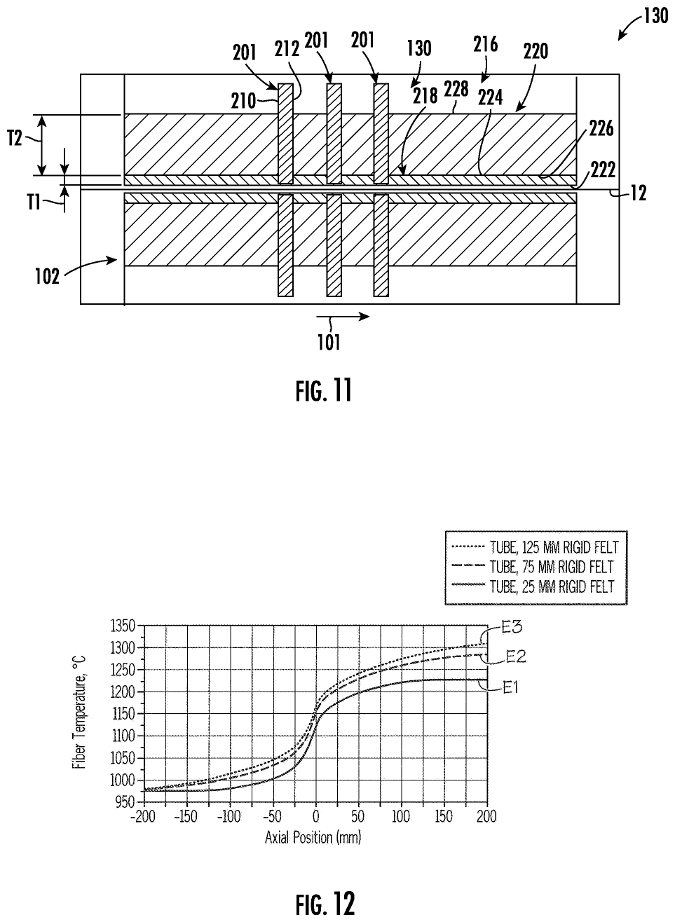

In the embodiments disclosed herein, the reheating device 130 includes a plurality of burners 201 and each burner 201 may be individually insulated by an insulating member 216 to reduce the fictive temperature of the optical fiber 12. Referring now to FIG. 11, the reheating device 130 includes a plurality of burners 201 spaced apart from another and arranged in an array extending along at least a portion of the fiber conveyance pathway 102. As shown, the insulating member 216 encloses at least a portion of the fiber conveyance pathway 102 and extends along the fiber conveyance pathway 102 in the fiber conveyance direction 101 and on opposite sides of each burner 201. In embodiments, the insulating member 216 includes a first insulating layer 218 and a second insulating layer 220 provided on the first insulating layer 218 opposite the fiber conveyance pathway 102. The first insulating layer 218 and the second insulating layer 220 each encircles the fiber conveyance pathway 102 and are positioned at adjacent opposite top and bottom surfaces 210, 212 of the bodies 202. The first insulating layer 218 has an inward-facing surface 222 and an opposite outward-facing surface 224. The first insulating layer 218 has a first insulating layer thickness T1 extending in a direction transverse to the fiber conveyance pathway 102. In embodiments, the first insulating layer thickness T1 is greater than or equal to 4 mm and less than or equal to 10 mm. In embodiments, the first insulating layer thickness T1 is greater than or equal to 6 mm and less than or equal to 8 mm. In embodiments, the first insulating layer 218 includes at least one of a glass and ceramic. In embodiments, the first insulating layer 218 includes silicon dioxide. In embodiments, the first insulating layer 218 includes a fused quartz tube. The second insulating layer 220 similarly has an inward-facing surface 226 provided on the outward-facing surface 224 of the first insulating layer 218, and an opposite outward-facing surface 228. Thus, the second insulating layer 220 surrounds the first insulating layer 218. The second insulating layer 220 has a second insulating layer thickness T2 extending in a direction transverse to the fiber conveyance pathway 102. In embodiments, the second insulating layer thickness T2 is greater than or equal to 10 mm and less than or equal to 250 mm. In embodiments, the second insulating layer thickness T2 is greater than or equal to 50 mm and less than or equal to 200 mm. In embodiments, the second insulating layer thickness T2 is greater than or equal to 70 mm and less than or equal to 250 mm. In embodiments, the second insulating layer thickness T2 is greater than or equal to 100 mm and less than or equal to 150 mm. In embodiments, the second insulating layer 220 comprises a cloth. In embodiments, the cloth comprises fiberglass reinforced felt.

Referring now to FIG. 12, a plot indicating modeled data of fiber temperature versus fiber axial position of a reheating device 130 with a single burner 201 is depicted. FIG. 12 includes a plot line E1, a plot line E2, and a plot line E3 each representing an insulating member wherein the second insulating layer 220 has a different second insulating layer thickness T2. For example, E1 represents an insulating member 216 having a second insulating layer thickness T2 of 25 mm, the plot line E2 represents an insulating member 216 having a second insulating layer thickness T2 of 75 mm, and the plot line E3 represents an insulating member 216 having a second insulating layer thickness T2 of 125 mm.

The plot line E1 indicates a temperature between 1,100° C. and 1,150° C. at the center plane of the reheating device 130, and a maximum temperature between 1,200° C. and 1,250° C. at 200 mm from the center plane of the reheating device 130. The plot line E2 indicates a temperature of about 1,150° C. at the center plane of the reheating device 130, and a maximum temperature between 1,250° C. and 1,300° C. at 200 mm from the center plane, and thus greater than the maximum temperature of plot line E1. The plot line E3 indicates a temperature between 1,150° C. and 1,200° C. at the center plane of the reheating device 130, and a maximum temperature between 1,300° C. and 1,350° C. at 200 mm from the center plane, and thus greater than the maximum temperature of the plot line E1 and the plot line E2. Accordingly, it is preferred that the optical fiber production apparatus 100 includes the insulating member 216 and particularly an insulating member 216 having a second insulating layer thickness T2 greater than 75 mm.

From the above, it is to be appreciated that defined herein is an optical fiber production apparatus for drawing an optical fiber from an optical fiber preform including a reheating device including a plurality of burners and each burner including a plurality of gas outlets configured to direct a flammable gas into a fiber conveyance pathway through which the optical fiber passes. Although various parameters of the optical fiber product apparatus are discussed herein and modified to provide optimal fiber heating temperatures and reducing a fictive temperature of the resulting optical fiber, it should be appreciated that any combination of the parameters discussed herein, for example, the number and gas outlet diameter of the gas outlets, the orientation of the gas outlets relative to the fiber conveyance pathway, the aperture diameter of each burner, and the presence and thickness of the insulating member each contributes to the resulting fiber heating temperature and heating rate.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A method of heating an optical fiber, the method comprising:
flowing gas from a common gas channel into one or more gas outlets of a burner, the common gas channel encircling an aperture of the burner; and
igniting the gas to form a flame and heating the fiber with the flame as the fiber passes through the aperture,
the one or more gas outlets opening into the aperture such that each gas outlet has a gas outlet bore terminating at an inward-facing wall of the burner that defines the aperture, and
the gas outlet bore being oriented at an angle θ₁ defined between the gas outlet bore and the inward-facing wall of the burner, downstream of the gas outlet bore, that is greater than or equal to 10 degrees and less than or equal to 70 degrees.

2. The method of claim 1, wherein the angle θ₁ is greater than or equal to 20 degrees and less than or equal to 60 degrees.

3. The method of claim 2, wherein the angle θ₁ is greater than or equal to 30 degrees and less than or equal to 50 degrees.

4. The method of claim 1, further comprising heating the burner with the flame to a peak heating rate of equal to or greater than 60,000 degrees Celsius per second.

5. The method of claim 1, wherein a diameter of the aperture is greater than or equal to 5 mm and less than or equal to 25 mm.

6. The method of claim 5, wherein a diameter of the one or more gas outlets is greater than or equal to 0.5 mm and less than or equal to 1.5 mm.

7. The method of claim 6, further comprising conveying the fiber along a fiber conveyance pathway, the aperture being positioned along the fiber conveyance pathway, and wherein at least a portion of the fiber conveyance pathway is enclosed by an insulating member such that the insulating member is disposed on opposite sides of the burner.

8. The method of claim 7, wherein the insulating member comprises a fused quartz tube surrounded by felt.

9. A method of heating an optical fiber, the method comprising:
flowing gas from a common gas channel into one or more gas outlets of a burner, the common gas channel encircling an aperture of the burner; and
igniting the gas to form a flame and heating the fiber with the flame as the fiber passes through the aperture,
the one or more gas outlets opening into the aperture such that each gas outlet has a gas outlet bore terminating at an inward-facing wall of the burner that defines the aperture,
the aperture having a diameter greater than or equal to 5 mm and less than or equal to 25 mm, and
the one or more gas outlets each having a diameter between 0.5 mm and 1.5 mm.

10. The method of claim 9, wherein the gas outlet bore is oriented at an angle θ₁ defined between the gas outlet bore and the inward-facing wall of the burner, downstream of the gas outlet bore, that is greater than or equal to 20 degrees and less than or equal to 30 degrees.

11. The method of claim 10, wherein the angle θ₁ is greater than or equal to 30 degrees and less than or equal to 50 degrees.

12. The method of claim 9, further comprising heating the burner with the flame to a peak heating rate of equal to or greater than 60,000 degrees Celsius per second.

13. The method of claim 9, wherein the diameter of the aperture is greater than or equal to 7 mm and less than or equal to 14 mm.

14. The method of claim 9, further comprising conveying the fiber along a fiber conveyance pathway, the aperture being positioned along the fiber conveyance pathway, and wherein at least a portion of the fiber conveyance pathway is enclosed by an insulating member such that the insulating member is disposed on opposite sides of the burner.

15. The method of claim 14, wherein the insulating member comprises a fused quartz tube surrounded by felt.

16. A method of heating an optical fiber, the method comprising:
flowing gas from a common gas channel into one or more gas outlets of a burner, the common gas channel encircling an aperture of the burner; and
igniting the gas to form a flame and heating the fiber with the flame as the fiber passes along a fiber conveyance pathway and through the aperture,
the one or more gas outlets opening into the aperture such that each gas outlet has a gas outlet bore terminating at an inward-facing wall of the burner that defines the aperture, and
an insulating member extending along the fiber conveyance pathway and on opposite sides of the burner.

17. The method of claim 16, wherein the insulating member comprises a first insulating layer comprising at least one of glass and ceramic that includes silicon dioxide.

18. The method of claim 17, wherein the first insulating layer includes fused quartz.

19. The method of claim 17, wherein the first insulating layer is surrounded by a cloth.

20. The method of claim 19, wherein the cloth comprises fiberglass reinforced felt.
